(19) United States
(12) Patent Application Publication
(10) Pub. No.: US 2026/0030865 A1
(43) Pub. Date: Jan. 29, 2026

(54) METHOD AND APPARATUS FOR OBTAINING TEMPORAL CHARACTERISTIC

(71) Applicant: SAMSUNG ELECTRONICS CO., LTD., Suwon-si (KR)

(72) Inventors: Minjung SON, Suwon-si (KR); Jaeyoung MOON, Suwon-si (KR); Nahyup KANG, Suwon-si (KR); Juyoung LEE, Suwon-si (KR)

(73) Assignee: SAMSUNG ELECTRONICS CO., LTD., Suwon-si (KR)

(21) Appl. No.: 19/013,614

(22) Filed: Jan. 8, 2025

(30) Foreign Application Priority Data
Jul. 24, 2024 (KR) 10-2024-0097842

(51) Int. Cl. G06V 10/62; G06T 3/18; G06T 5/70; G06T 7/20; G06V 10/26; G06V 10/75

(52) U.S. Cl. CPC G06V 10/62; G06T 3/18; G06T 5/70; G06T 7/20; G06V 10/26; G06V 10/751; G06T 2207/20081; G06T 2207/20084

(57) ABSTRACT

A method of obtaining a temporal characteristic may include obtaining a first image at a first time point, a second image at a second time point preceding the first time point, and a third image at third time point preceding the second time point, reconstructing the second image based on first motion information of the first image, calculating a first temporal difference between the first image and the reconstructed second image, reconstructing the third image based on second motion information of the second image, calculating a second temporal difference between the second image and the reconstructed third image, reconstructing the second temporal difference based on the first motion information, calculating a third temporal difference between the reconstructed second temporal difference and the first temporal difference, and obtaining a temporal characteristic of the first image based on the third temporal difference.

### CROSS-REFERENCE TO RELATED APPLICATION

This application claims priority from Korean Patent Application No. 10-2024-0097842, filed on Jul. 24, 2024, in the Korean Intellectual Property Office, the disclosure of which is incorporated herein by reference in its entirety.

### BACKGROUND

### 1. Field

Methods and apparatuses consistent with embodiments relate to obtaining temporal characteristics of images.

### 2. Description of the Related Art

Three-dimensional (3D) rendering may refer to creating realistic or stylized images from various pieces of information such as 3D geometry, lighting, and materials of a scene. While there are numerous rendering techniques available, to perform high-quality rendering in terms of resolution, image effect, and other factors, many image samples and numerous operations may be required.

For example, when rendering is performed in a short time or applied to an interactive application, such as a game, the number of samples may be reduced for fast processing. As a result, the rendering quality may deteriorate, artifacts may occur in the rendering result, and/or temporal stability may deteriorate.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of the disclosure, a method of obtaining a temporal characteristic may include: obtaining a first image at a first time point, a second image at a second time point preceding the first time point, and a third image at third time point preceding the second time point; reconstructing the second image based on first motion information of the first image; calculating a first temporal difference between the first image and the reconstructed second image; reconstructing the third image based on second motion information of the second image; calculating a second temporal difference between the second image and the reconstructed third image; reconstructing the second temporal difference based on the first motion information; calculating a third temporal difference between the reconstructed second temporal difference and the first temporal difference; and obtaining a temporal characteristic of the first image based on the third temporal difference.

The calculating of the first temporal difference may include: obtaining the first motion information; warping the second image based on the first motion information; and calculating the first temporal difference by comparing the warped second image with the first image.

The calculating of the second temporal difference may include: obtaining the second motion information; warping the third image based on the second motion information; and calculating the second temporal difference by comparing the warped third image with the second image.

The first motion information and the second motion information may include either one or both of a motion vector and optical flow.

The method may further include: preprocessing at least some area of at least one of the first image, the second image, the third image, the reconstructed second image, and the reconstructed third image.

The preprocessing may include at least one of: adding blur to the at least some area; and smoothing the at least some area.

At least one of the first temporal difference, the second temporal difference, and the third temporal difference may be defined in a form of a spatial map.

The at least one of the first temporal difference and the second temporal difference may include at least one of: a difference between pixels mapped to each other in input images at each time point; a difference between areas mapped to each other in the input images at the each time point; a difference based on features extracted from the input images at the each time point; a difference between image error metrics corresponding to the input images at the each time point; and a difference between maps or images corresponding to the input images at the each time point.

The method may include: estimating occlusion areas in the first, second and third images based on additional information corresponding to the first, second, and third images; and removing the occlusion areas from the first, second, and third images by masking the occlusion areas.

At least one of the first temporal difference, the second temporal difference, and the third temporal difference may be calculated for the first, second, and third images from which the occlusion areas are removed.

The additional information may include at least one of depth information corresponding to the first, second, and third images, normal information corresponding to at least one object included in the first, second, and third images, and object identification (ID) information corresponding to the at least one object.

The calculating of the third temporal difference may include: processing a spatial map corresponding to the third temporal difference; and estimating, as the third temporal difference, a value calculated as a result of the processing.

The processing of the spatial map may include: comparing pixel values of the spatial map corresponding to the third temporal difference with a threshold; and calculating, as the third temporal difference, a value obtained by averaging results of the comparison with the threshold.

The processing of the spatial map may include calculating at least one of a weighted average, a mean squared error (MSE), a peak signal-to-noise ratio (PSNR), and a structural similarity (SSIM) index for pixel values of the spatial map corresponding to the third temporal difference.

The obtaining of the temporal characteristic may include obtaining the temporal characteristic by comparing the estimated value with a preset reference.

The method may further include: updating the first image based on the temporal characteristic.

The method may further include: adaptively adjusting a rendering quality by training a neural network that renders the first, second, and third images, based on the temporal characteristic.

According to another aspect of the disclosure, a method of obtaining a temporal characteristic may include: obtaining a first image and a first ground truth (GT) at a first time point, a second image and a second GT image at a second time point preceding the first time point, and a third image and a third GT image at third time point preceding the second time point; warping the second image based on 1-1 motion information of the first image; calculating a 1-1 temporal difference between the first image and the warped second image; warping the third image based on 2-1 motion information of the second image; calculating a 2-1 temporal difference between the second image and the warped third image; warping the 2-1 temporal difference based on the 1-1 motion information; calculating a 3-1 temporal difference between the warped 2-1 temporal difference and the 1-1 temporal difference; warping the second GT image based on 1-2 motion information of the first GT image; calculating a 1-2 temporal difference between the first GT image and the warped second GT image; warping the third GT image based on 2-2 motion information of the second GT image; calculating a 2-2 temporal difference between the second GT image and the third GT image; warping the 2-2 temporal difference based on the 1-2 motion information; calculating a 3-2 temporal difference between the warped 2-2 temporal difference and the 1-2 temporal difference; calculating a fourth temporal difference between the 3-1 temporal difference and the 3-2 temporal difference; and obtaining a temporal characteristic of the first image based on the fourth temporal difference.

According to another aspect of the disclosure, a method of obtaining a temporal characteristic may include: obtaining an input image including a first frame, a second frame preceding the first frame, and a third frame preceding the second frame; reconstructing the second frame based on first motion information of the first frame; calculating a first temporal difference between the reconstructed second frame and the first frame; reconstructing the third frame based on second motion information of the second frame; calculating a second temporal difference between the reconstructed third frame and the second frame; reconstructing the second temporal difference based on the first motion information; calculating a third temporal difference between the reconstructed second temporal difference and the first temporal difference; obtaining a temporal characteristic of the first frame based on the third temporal difference; and updating the first frame based on the temporal characteristic.

The reconstructing of the second frame may include: obtaining the first motion information; and warping the second frame preceding the first frame by the first motion information, wherein the calculating of the first temporal difference may include calculating the first temporal difference by comparing the warped second frame with the first frame.

### BRIEF DESCRIPTION OF THE DRAWINGS

The above and/or other aspects will be more apparent by describing certain embodiments, taken in conjunction with the accompanying drawings, in which:

FIG. 1 is a flowchart illustrating a method of obtaining a temporal characteristic, according to an embodiment;

FIG. 2 is a diagram illustrating a method of calculating a first temporal difference and a second temporal difference, according to an embodiment;

FIG. 3 is a diagram illustrating a method of calculating a third temporal difference, according to an embodiment;

FIG. 4 is a flowchart illustrating a method of obtaining a temporal characteristic using a ground truth (GT) image, according to an embodiment;

FIG. 5 is a diagram illustrating a process of obtaining a temporal characteristic by the method of FIG. 4;

FIG. 6 is a flowchart illustrating a method of obtaining a temporal characteristic, according to an embodiment; and

FIG. 7 is a block diagram of an electronic device for obtaining a temporal characteristic, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Embodiments to be described below may be applied, for example, to a neural network, a processor, a smartphone, a mobile device, a display, and a rendering apparatus that are to perform three-dimensional (3D) rendering.

Hereinafter, embodiments will be described in detail with reference to the accompanying drawings. When describing the embodiments with reference to the accompanying drawings, like reference numerals refer to like elements and a repeated description related thereto will be omitted.

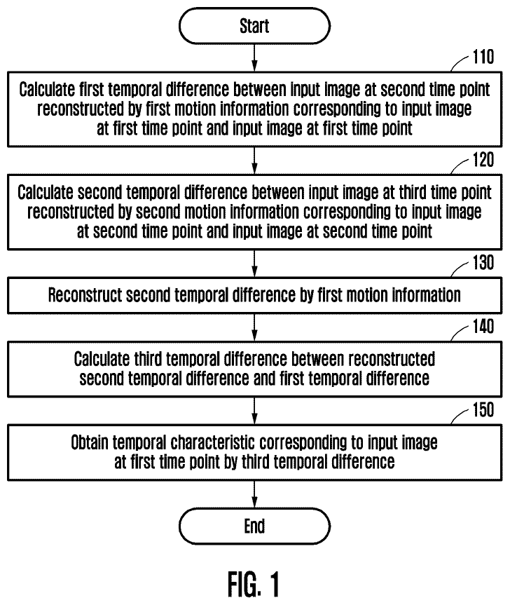

FIG. 1 is a flowchart illustrating a method of obtaining a temporal characteristic of images, according to an embodiment. Operations to be described with reference to FIG. 1 and below may be performed sequentially but not necessarily. For example, the order of the operations may change and at least two of the operations may be performed in parallel or one operation may be performed separately.

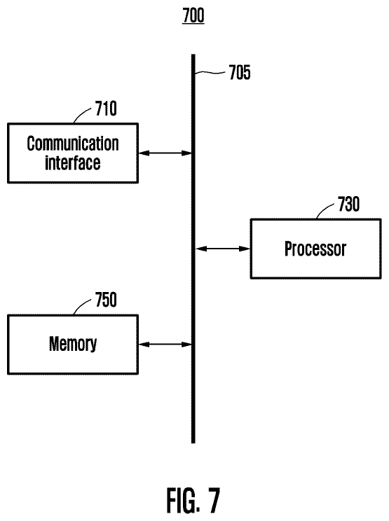

Referring to FIG. 1, an electronic device according to an embodiment may obtain a temporal characteristic of images through operations 110 to 150. The electronic device may be, but is not necessarily limited thereto, for example, a rendering apparatus that generates a rendering result image to which realistic rendering is applied through neural rendering. The electronic device may be an electronic device 700 of FIG. 7.

The electronic device may obtain an input image at a first time point, and reconstruct the input image at a second time point based on first motion information of the input image obtained at the first time point. In operation 110, the electronic device may calculate a first temporal difference between the input image at the second time point and the input image at the first time point. For example, the input images may correspond to images obtained at consecutive time points such as a first time point, a second time point, and a third time point. The second time point may be a time point preceding the first time point, and the third time point may be a time point preceding the second time point. For example, an input image at the first time point may be an image (or an image frame) corresponding to a current time point t, an input image at the second time point may be an image corresponding to a time point t-1, and an input image at the third time point may be an image corresponding to a time point t-2. Alternatively, the input image at the first time point may be an image corresponding to the time point t, the input image at the second time point may be an image corresponding to the time point t-2, and the input image at the third time point may be an image corresponding to a time point t-5, assuming the electronic device obtains images at consecutive time points t-5, t-4, t-3, t-2, t-1, and t. The input images may be, for example, rendering result images obtained by the rendering apparatus that generates an output image to which realistic rendering is applied in real time. The input images may be, but are not necessarily limited thereto, images captured by a camera.

The term ‘temporal difference’ used herein refers to a difference between consecutive images on different time axes and may also be referred to as a ‘difference between temporal images.’

In operation 110, the electronic device may obtain the first motion information. The first motion information may be, for example, information indicating motion corresponding to the input image at the first time point. Herein, the ‘information indicating motion corresponding to an input image’ may be understood as information indicating motion of an object(s) included in the input image. The first motion information may be, for example, a motion vector corresponding to the input image at the first time point or optical flow but is not necessarily limited thereto.

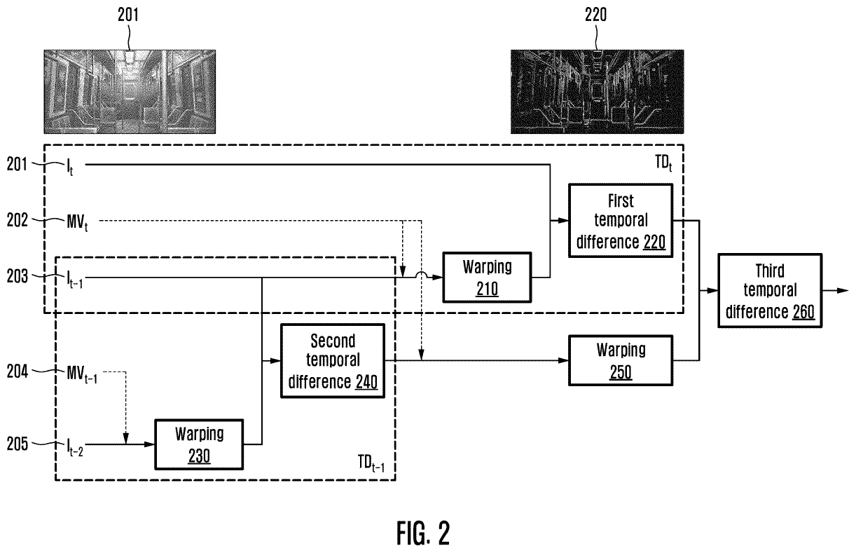

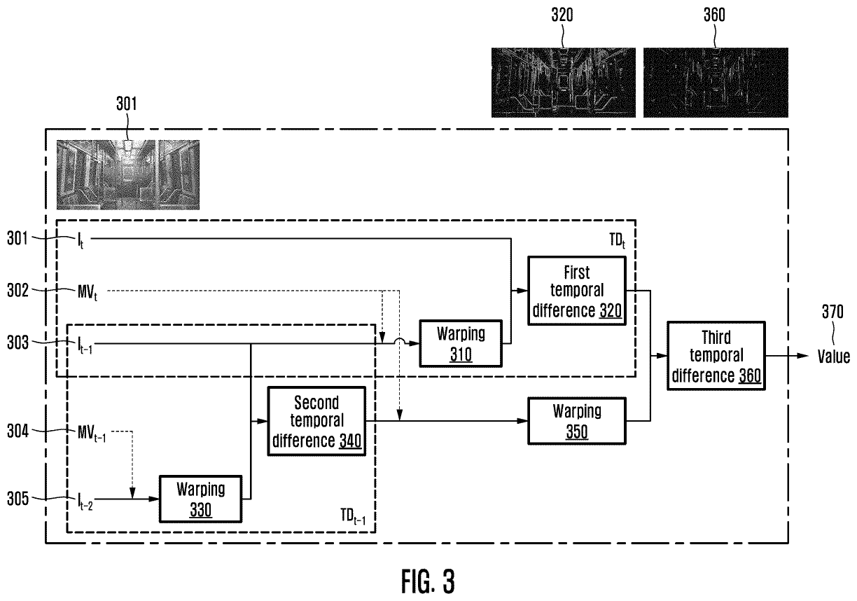

The electronic device may reconstruct the input image at the second time point by warping the input image at the second time point preceding the input image at the first time point by the first motion information. Here, the ‘reconstructed input image at the second time point’ may also be referred to as a ‘warped input image at the second time point’ in that the ‘reconstructed input image at the second time point’ is reconstructed to the input image at the first time point through warping. The electronic device may calculate the first temporal difference by comparing the reconstructed (warped) input image at the second time point with the input image at the first time point. The first temporal difference may be defined in the form of, for example, a spatial map, but is not necessarily limited thereto. Here, the ‘spatial map’ may correspond to a two-dimensional (2D) map or a 2D image including temporal information or time-based information. For example, the spatial map may be a 2D map such as a first temporal difference 220 illustrated in FIG. 2, a first temporal difference 320 illustrated in FIG. 3, and/or a third temporal difference 360.

In operation 120, the electronic device may calculate a second temporal difference between the input image at the second time point and an input image at a third time point that is reconstructed by second motion information of the input image at the second time point. In operation 120, the electronic device may obtain the second motion information. The second motion information may be, for example, a motion vector corresponding to the input image at the second time point or optical flow but is not necessarily limited thereto. The electronic device may reconstruct the input image at the third time point by warping the input image at the third time point preceding the input image at the second time point by the second motion information. Here, the ‘reconstructed input image at the third time point’ may also be referred to as a ‘warped input image at the third time point’ in that the ‘reconstructed input image at the third time point’ is reconstructed to the input image at the second time point through warping.

The electronic device may calculate the second temporal difference by comparing the reconstructed (warped) input image at the third time point with the input image at the second time point. The second temporal difference may be defined in the form of, for example, a spatial map, but is not necessarily limited thereto.

The electronic device may calculate a temporal difference (e.g., the first temporal difference and/or the second temporal difference) by a difference operation between a reconstructed image and an original image. The difference operation may refer to, for example, an operation of subtracting values of pixels at the same location in two images, that is, values of pixels mapped to the same location in two images. Alternatively, the difference operation may be performed by a method of comparing difference images by various image metrics or a method of calculating the temporal difference by connecting difference images to time axes.

At least one of the first temporal difference and the second temporal difference may include, but is not necessarily limited thereto, at least one of, for example, a difference between pixels mapped to each other in input images at each time point, a difference between areas mapped to each other in the input images at each time point, a difference based on features extracted from the input images at each time point, a difference between image error metrics corresponding to the input images at each time point, and a difference between maps or images corresponding to the input images at each time point.

Here, the features extracted from the input images at each time point may also be referred to as ‘deep features’ in that the features are extracted by, for example, a deep neural network.

The ‘image error metrics’ may be used to measure the quality of an image. The image error metrics may be used to quantify errors (e.g., root mean squared (RMS) errors) of a target image through comparison between an original image with the target image.

The first temporal difference and the second temporal difference may correspond to a method of obtaining a difference corresponding to the 1st derivative or the second derivative. For example, when comparing two images (e.g., an original image and a warped version of the original image), a difference image D(x, y) may be obtained by subtracting pixels values I₁ (x, y) of a first image I₁ from pixels values I₂ (x, y) of a second image I₂ and by measuring the direction and magnitude of changes in pixel values in the x (horizontal) and y (vertical) directions. According to embodiments of the present disclosure, the second derivative applied to both the first and second temporal differences may be used in both spatial and temporal domains, in contrast to related art that applies the second derivative solely in the temporal domain.

In operation 130, the electronic device may reconstruct the second temporal difference by the first motion information. Here, the reconstruction may be performed through the warping described above but is not necessarily limited thereto.

In operation 140, the electronic device may calculate a third temporal difference between the second temporal difference reconstructed in operation 130 and the first temporal difference calculated in operation 110. The electronic device may process a spatial map corresponding to the third temporal difference.

Various methods of processing the spatial map by the electronic device are described below but are not necessarily limited thereto.

The electronic device may compare pixel values of the spatial map corresponding to the third temporal difference with a threshold and calculate, as the third temporal difference, a value obtained by averaging results of the comparison with the threshold. In addition, the electronic device may calculate at least one of a weighted average, a mean squared error (MSE), a peak signal-to-noise ratio (PSNR), and a structural similarity (SSIM) index for the pixel values of the spatial map corresponding to the third temporal difference. The weighted average, the MSE, the PSNR, and the SSIM for the pixel values of the spatial map may correspond to methods of measuring a similarity between images.

The MSE may be a method of measuring an average squared difference between a predicted value (a generated or reconstructed image) and an actual value (an original image). The MSE may be calculated by squaring differences in pixel values included within a pixel unit, summing all the squared differences, and then averaging the differences. The MSE may be used to evaluate how closely images match each other, focusing on the accuracy of pixel colors.

The PSNR may be a method of comparing the maximum possible power of a signal with the power of noise that damages or distorts the signal. According to the PSNR, the signal may correspond to a pixel value of an original image, and the noise may correspond to a difference between a pixel value of an error image (e.g., an image that has lost data due to compression) and the original image. Especially in image processing, the PSNR may be used to evaluate the image quality or loss, with high values indicating a more accurate reconstruction or approximation of the original image. The PSNR is a variation of the MSE and may focus on pixel-by-pixel comparison.

The SSIM may be used to evaluate a similarity between two images (e.g., a reconstructed image and an input image) by considering three factors such as a structure, brightness, and contrast of images. The SSIM may mimic the way a human visual system perceives an image and evaluate the similarity between images from a more human perspective by comparing structural characteristics of the images rather than simply comparing the differences in pixel values. Unlike the MSE or the PSNR, the SSIM may evaluate whether the texture, structure, and brightness of the images are similar and focus more on ‘how similar the images look’ rather than simply focusing on the accuracy of colors.

The SSIM may better evaluate the qualitative side of the images than the MSE or the PSNR in that the SSIM focuses more on the structural aspect of the images and human visual perception rather than on whether pixel values match exactly in the images. For example, when two images have slightly different colors but are structurally very similar, the SSIM may give a high score to the two images, but the MSE or the PSNR may give a low score to the two images. In this way, the SSIM may evaluate rich visual information by considering more complex factors such as the structure and texture of the images.

The electronic device may estimate, as the third temporal difference, a value calculated as a result of processing. The electronic device may obtain the temporal characteristic by comparing the estimated value with a preset reference in operation 140. The third temporal difference may be defined in the form of a spatial map but is not necessarily limited thereto. The third temporal difference may be a difference corresponding to the 1st derivative or the 2nd derivative. For example, the electronic device may calculate the first temporal difference and the second temporal difference as the first derivative, and may calculate the third temporal difference as the second derivative.

In some embodiments of the present disclosure, using the second derivative for the third temporal difference offers technical benefits compared to using the first derivative. When the first derivative is used, in addition to capturing the temporally unstable component, errors may also include brightness changes due to temporally changed lighting or temporally changed view in the specular object. In contrast, using the second derivative may avoid capturing these relatively temporally smooth brightness changes in the specular object, and instead isolates only the unwanted temporally unstable component as an error. By measuring temporal stability based on the second derivative, the system may also better respond to lighting changes. Specifically, the embodiments of the present disclosure define temporal difference using the difference from the warped previous frame, and measures temporal stability by comparing the difference from the temporal difference of the warped previous frame. This approach may allow for accurate temporal stability measurement in scenes with various conditions, such as brightness changes or specular reflections.

In operation 150, the electronic device may obtain the temporal characteristic corresponding to the input image at the first time point by the third temporal difference calculated in operation 140. The term ‘temporal characteristic’ used herein refers to ‘temporal stability’ and may also be referred to as the term ‘temporal consistency.’ The temporal stability may refer to a temporally consistent characteristic (e.g., a characteristic in which changes between image frames are maintained smoothly and consistently) in an image. The temporal characteristic may also be output in the form of a certain value indicating the degree to which a certain characteristic is temporally consistent in the image. The temporal characteristic may be used as an indicator for examining the reliability between two images. The temporal characteristic may also be used for training the rendering apparatus that outputs an input image (a rendered image). In addition, the temporal characteristic may also be used for adjusting a parameter of a neural network included in the rendering apparatus to adaptively adjust the rendering quality.

In one or more embodiments of the disclosure, the electronic device may obtain a temporal difference at a specific time point, by comparing an image acquired at the specific time with a reconstructed version of an image obtained at an earlier time, wherein the earlier image is reconstructed (or warped) to align with the current image. For example, the electronic device may obtain a first image at the current time point t₀ (e.g., the input image at the first time point) and a second image at an earlier time point t₋₁ (e.g., the input image at the second time point). The electronic device may reconstruct the second image by warping it based on a motion vector of the first image, allowing the electronic device to capture a temporal difference at the current time point (e.g., the first temporal difference) based on a difference between the first image and the reconstructed second image. To obtain a temporal difference at the earlier time point t₋₁ (e.g., the second temporal difference), the electronic device may use a third image that is obtained at an even earlier time point t₋₂ (e.g., the input image at the third time point). The electronic device may reconstruct the third image by warping it based on a motion vector of the second image, and then may calculate a temporal difference at the earlier time point t₋₁ (e.g., the second temporal difference) based on a difference between the second image and the warped third image. The electronic device may determine the temporal stability of the first image at the current time point t₀ by comparing the first temporal difference with the second temporal difference, which is reconstructed using the motion vector of the first image.

Since the temporal characteristic may be used as the indicator for examining the reliability between two images, in operation 150, the electronic device may be expressed as an electronic device for ‘measuring’ the temporal characteristic corresponding to the input image at the first time point by the third temporal difference.

The electronic device may update the input image at the first time point, based on the temporal characteristic obtained from operation 150. Alternatively or additionally, the electronic device may adaptively adjust the rendering quality by training the neural network that renders the input image, based on the temporal characteristic obtained from operation 150.

According to an embodiment, the electronic device may preprocess an input image and/or a reconstructed input image to reduce a difference caused by the reconstruction of an image. For example, the electronic device may reduce the influence of noise by preprocessing at least some area of at least one of the input image at the first time point, the input image at the second time point, the input image at the third time point, the reconstructed input image at the second time point, and the reconstructed input image at the third time point. For example, ‘at least some area’ may be, but is not necessarily limited thereto, an area where an error does not occur in at least one image during rendering or reconstruction.

Here, ‘preprocessing’ may include, but is not necessarily limited thereto, for example, pixel processing that changes a value in a pixel based on an original value or location of the pixel, area processing that changes a value based on a pixel value generated by relating the original value of the pixel to multiple neighboring pixels, geometry processing that rotates or enlarges an image as a method of changing a location or arrangement of a digital image pixel, and frame processing that generates a new pixel value by combining various operations with two or more different images. The area processing may include, but is not necessarily limited thereto, blurring that adds blur that makes at least a portion of an image blurry, smoothing that makes at least a portion of an image smooth, adaptive smoothing that adaptively makes at least a portion of an image smooth, and sharpening that makes the edge of an image stand out.

In addition, when there is additional information corresponding to an input image, the electronic device may estimate and remove occlusion areas from the input image and then compare the input image with the image from which the occlusion areas are removed. More specifically, the electronic device may estimate the occlusion areas in the

input image using the additional information corresponding to the input image. The additional information corresponding to the input image may include, for example, at least one of depth information corresponding to the input image, normal information corresponding to at least one object included in the input image, and object identification (ID) information corresponding to the at least one object but is not necessarily limited thereto.

For example, when the object ID information of a corresponding portion is changed in a reconstructed (or warped) image, since the motion information (e.g., the motion vector) exists but the object ID information of the corresponding portion is changed due to the reconstruction (or warping), the corresponding portion may be considered as an occlusion area. In this case, the electronic device may estimate a portion corresponding to the occlusion area in the input image by the object ID information corresponding to the input image. Here, the object ID information may be included in the input image in advance in the form of metadata or stored separately in the form of a database (DB).

For example, when the change in the depth information between the reconstructed (or warped) image and an image before reconstruction is greater than a predetermined reference, the electronic device may estimate, as the occlusion area, a portion of which the change in the depth information is greater than the predetermined reference in the reconstructed (or warped) image. Alternatively, when the change in the normal information between the reconstructed (or warped) image and the image before reconstruction is greater than the predetermined reference, that is, when the distribution of pieces of normal that are relative to the reconstructed (or warped) image is significantly changed, the electronic device may estimate, as the occlusion area, a portion of which the change in the normal information is greater than the predetermined reference in the reconstructed (or warped) image.

Like the object ID information, the electronic device may determine whether objects included in the reconstructed (or warped) image are the same object, using the depth information and/or the normal information. The electronic device may remove the occlusion area from the input image by masking the occlusion area. According to an embodiment, the electronic device may remove or add the estimated object from or to the input image and then compare input images at each time point.

The electronic device may perform operations 110 to 150 described above on the input images from which the occlusion area is removed. When warping is applied to the input images, the occlusion area between two frames may not be observed in other frames, so one-to-one mapping and comparison between frames may not be possible. In this case, the electronic device may define the occlusion area as an occlusion mask in advance, using various pieces of additional information corresponding to the input images, and remove the occlusion mask during a difference operation.

FIG. 2 is a diagram illustrating a method of calculating a first temporal difference and a second temporal difference, according to an embodiment. Referring to FIG. 2, to measure a temporal characteristic (e.g., temporal stability) at a first time point Time t, an electronic device according to an embodiment may first obtain a temporal difference at the first time point Time t, a second time point Time t-1, and a third time point Time t-2, that is, the 1st derivative corresponding to the first temporal difference 220 and a second temporal difference 240.

More specifically, the electronic device may obtain the first temporal difference 220 at the first time point Time t by performing warping 210 on an input image Iₜ₋₁ 203 at a second time point using a motion vector MVₜ 202 at the first time point Time t corresponding to an input image Iₜ 201 at the first time point Time t and then measuring a difference between the warped input image Iₜ₋₁ 203 at the second time point and the input image Iₜ 201 at the first time point.

In addition, the electronic device may obtain the second temporal difference 240 at the second time point Time t-1 by performing warping 230 on an input image Iₜ₋₂ 205 at a third time point using a motion vector MVₜ₋₁ 204 at the second time point Time t-1 and then measuring a difference from the input image Iₜ₋₁ 203 at the second time point.

The electronic device may perform warping 250 on the second temporal difference 240 at the second time point Time t₋₁ using the motion vector MVₜ 202 at a first time point. Even when the brightness changes, the electronic device may measure the temporal characteristic by obtaining a third temporal difference 260 between the warped second temporal difference 240 and the first temporal difference 220. The third temporal difference 260 may correspond to the 2nd derivative.

The electronic device may also apply slight blur to the input image Iₜ 201, the input image Iₜ₋₁ 203, and the input image Iₜ₋₂ 205 to reduce a difference due to warping. In addition, when at least some of the input image Iₜ 201, the input image Iₜ₋₁ 203, and the input image Iₜ₋₂ 205 are general video images for which a separate motion vector is not given, the electronic device may obtain optical flow corresponding to at least some input images for which a motion vector is not given and use the optical flow as a motion vector.

The optical flow, which tracks the movement of an object in the input image It 201, the input image Iₜ₋₁ 203, and the input image Iₜ₋₂ 205, may represent the movement of each pixel between two consecutive frames in the form of a vector. The electronic device may identify in which direction and how fast the pixel or the object is moving through the optical flow. For example, the electronic device may obtain the optical flow using a dense optical flow-based method that calculates the movement of all pixels, a sparse optical flow-based method that tracks the movement by selecting only a certain feature point, and a deep learning-based method that estimates optical flow using a deep learning model (e.g., FlowNet, PWC-Net, LiteFlowNet, etc.) but is not necessarily limited thereto. The sparse optical flow-based method may include a Lucas-Kanade method that calculates the movement of each pixel locally.

Moreover, when the warping 210 and the warping 230 are applied, an occlusion area may arise between two frames (e.g., the input image Iₜ₋₁ 203 at the second time point and the input image Iₜ₋₂ 205 at the third time point). This occlusion area may represent a part of the scene that was occluded in a previous frame (e.g., the input image Iₜ₋₂ 205 at the third time point) but is now visible in a current frame (e.g., the input image Iₜ₋₁ 203 at the second time point). In this case, even when the input image Iₜ₋₂ 205 at the third time point is warped to align with the input image Iₜ₋₁ 203 at the second time point, establishing a one-to-one mapping and/or comparison between images may not be possible because the corresponding information is not present in the input image Iₜ₋₂ 205 at the third time point in the first place. To address this issue, the electronic device may define an area where one-to-one mapping is impossible as an ‘occlusion area’ and exclude the occlusion area from the comparison. The exclusion may also apply to an occlusion area between the input image Iₜ 201 at the first time point and the input image Iₜ₋₁ 203 at the second time point.

In this case, the electronic device may define the occlusion area as an occlusion mask in advance, based on additional information such as depth information, and remove the occlusion area during a difference operation. Here, the difference operation may be performed using comparison methods that are applied from a simple difference between mapped pixels to various image metrics.

For example, when the comparison between features extracted from input images at each time point and/or the comparison between image error metrics corresponding to the input images at each time point is used, the electronic device may obtain a relatively robust result without removing the occlusion area from the input images.

When the features extracted from the input images or the image error metrics are passed through a pre-trained neural network model (e.g., a visual geometry group (VGG) model) and compared, a higher level of comparison may be possible than a simple pixel-based comparison. Accordingly, even when incorrect information is included in a sparse occlusion area, the electronic device may stably perform inference through, for example, a reflection of edges more intensively or a high-level comparison such as a perceptual similarity or a feature (e.g., depth value) comparison.

Various methods may be used to calculate the temporal difference between the input images, and the method used to calculate the first temporal difference 220 and the second temporal difference 240 corresponding to the 1st derivative and the method used to calculate the third temporal difference 260 corresponding to the 2nd derivative may be the same or different.

The method of calculating the temporal difference may be applied to corresponding pixels or areas mapped to each other between images, and since the calculated second temporal difference 240 is represented as a spatial map, it may be possible to perform the warping 250 on the calculated second temporal difference 240 again.

The electronic device may calculate the third temporal difference 260 by comparing the first temporal difference 220 with the second temporal difference 240 to which the warping 250 has been applied.

FIG. 3 is a diagram illustrating a method of calculating a third temporal difference, according to an embodiment. Referring to FIG. 3, an electronic device according to an embodiment may measure a temporal characteristic corresponding to an input image It 301 at a first time point, based on warping using a moving vector such as a motion vector.

Here, the input image Iₜ 301 at the first time point may correspond to a rendering result image. In the rendering result image, very clear artifacts may appear in a sparse area in a part of an image. Such clear and sparse artifacts may be more noticeable in sequential image frames that are temporally connected to each other. This may be because the artifacts appear as noticeable flickering in different areas when the artifacts are temporally connected to each other, even when the artifacts are errors that appear in some areas in each image frame. However, since such artifacts are not easily revealed using a general image quality measurement method, the evaluation itself may be difficult by making a difference from the perceptual expectation when measuring the image quality and making the definition of loss for the artifact reduction in a training-based method difficult. In addition, due to the artifacts described above, it may be difficult to reflect parts of which values vary depending on a time point, such as lighting changes or specular light in the rendering result image.

In an embodiment, the temporal stability may be obtained based on warping using motion information (e.g., the motion vector), and it may be possible to respond to lighting changes by measuring the temporal stability based on the 2nd derivative rather than a simple difference (e.g., the 1st derivative).

More specifically, the electronic device may define the temporal difference using a difference between a warped previous frame and a current frame and may measure and/or obtain the temporal characteristic of scenes with various conditions, such as brightness changes or specular light, by measuring the temporal characteristic using a difference from the temporal difference of the warped previous frame.

To measure the temporal characteristic (e.g., the temporal stability) at the first time point Time t, the electronic device may first obtain the temporal difference at the first time point Time t and the second time point Time t-1, that is, the 1st derivative corresponding to the first temporal difference 320 and a second temporal difference 340.

More specifically, the electronic device may obtain the first temporal difference 320 at the first time point Time t by performing warping 310 on an input image Iₜ₋₁ 303 at a second time point using a motion vector MVₜ 302 at the first time point Time t corresponding to the input image Iₜ 301 at the first time point t and then measuring a difference between the warped input image Iₜ₋₁ 303 at the second time point and the input image Iₜ 301 at the first time point.

Additionally, the electronic device may obtain the second temporal difference 340 at the second time point Time t-1 by performing warping 330 on an input image Iₜ₋₂ 305 at a third time point using a motion vector MVₜ₋₁ 304 at the second time point Time t-1 and then measuring a difference between the input image Iₜ₋₁ 303 at the second time point with the warped input image Iₜ₋₂ 305 at the third time point.

The electronic device may perform warping 350 on the second temporal difference 340 at the second time point Time t-1 using the motion vector MV, 302 at the first time point Time t. Even when the brightness changes, the electronic device may measure the temporal characteristic by obtaining the third temporal difference 360 between the warped second temporal difference 340 and the first temporal difference 320, which corresponds to the 2nd derivative.

The electronic device may output the third temporal difference 360 in the form of a value 370 or may generate and output the third temporal difference 360 in the form of a spatial map. The electronic device may process the spatial map corresponding to the third temporal difference 360. When the third temporal difference 360 is given in the form of a spatial map, the electronic device may also estimate the value 370 using a method of obtaining an average of the spatial map, etc.

The value 370 estimated through the process described above is used as loss during training of a neural network that renders an input image and may be used to obtain a training result with an improved temporal characteristic. In addition, the estimated value 370 may be used to measure the degree of temporal stability of the results (e.g., input images or image frames) that are already generated by a rendering apparatus.

According to an embodiment, the method of obtaining a temporal characteristic may be used as the method of measuring the temporal characteristic (e.g., the temporal stability) during rendering by an electronic device that performs rendering. The electronic device may provide a more stable interactive rendering result to a user by adaptively adjusting the rendering quality of an image in real time according to the degree of temporal characteristic during rendering.

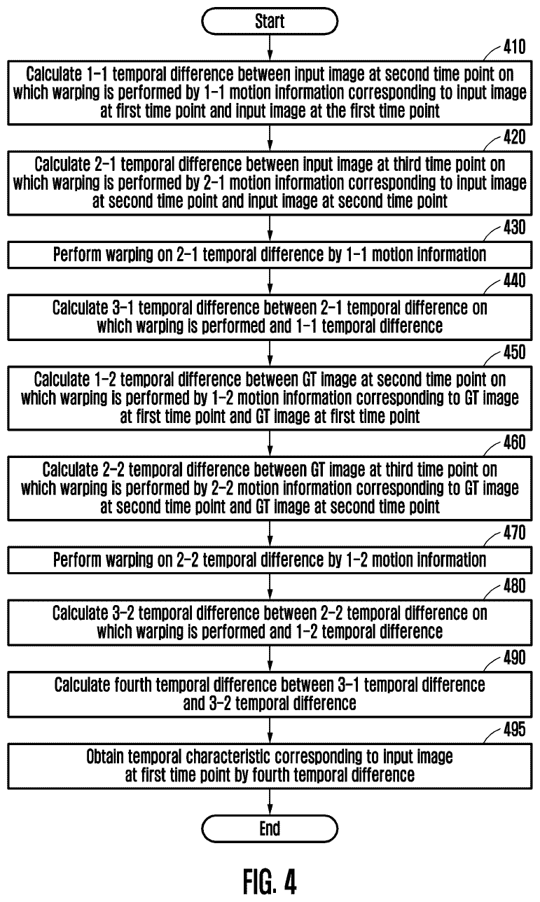

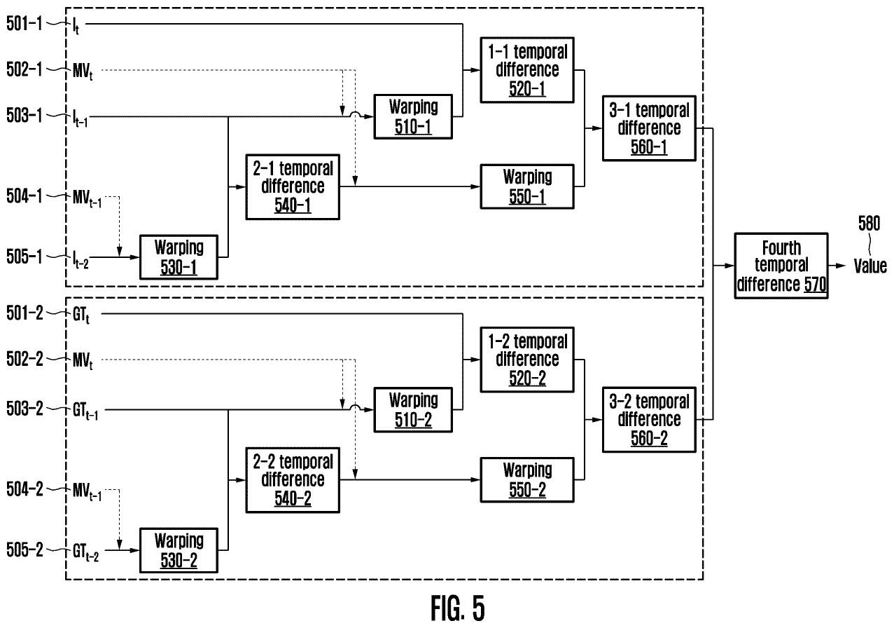

FIG. 4 is a flowchart illustrating a method of obtaining a temporal characteristic using a ground truth (GT) image, according to an embodiment, and FIG. 5 is a diagram illustrating a process of obtaining a temporal characteristic by the method of FIG. 4.

Referring to FIGS. 4 and 5, an electronic device according to an embodiment may obtain a temporal characteristic corresponding to an input image at a first time point through operations 410 to 495. The electronic device may obtain the temporal characteristic using input images corresponding to rendering images and GT images corresponding to the rendering images together.

In operation 410, the electronic device may calculate a 1-1 temporal difference 520-1 between an input image Iₜ₋₁ 503-1 at a second time point on which warping 510-1 is performed by 1-1 motion information MVₜ 502-1 corresponding to an input image Iₜ 501-1 at a first time point and the input image Iₜ 501-1 at the first time point.

In operation 420, the electronic device may calculate a 2-1 temporal difference 540-1 between an input image Iₜ₋₂ 505-1 at a third time point on which warping 530-1 is performed by 2-1 motion information MVₜ₋₁ 504-1 corresponding to the input image Iₜ₋₁ 503-1 at the second time point and the input image Iₜ₋₁ 503-1 at the second time point.

In operation 430, the electronic device may perform warping 550-1 on the 2-1 temporal difference 540-1 by the 1-1 motion information MVₜ 502-1.

In operation 440, the electronic device may calculate a 3-1 temporal difference 560-1 between the 2-1 temporal difference 540-1 on which the warping 550-1 is performed in operation 430 and the 1-1 temporal difference 520-1 calculated in operation 410.

In operation 450, the electronic device may calculate a 1-2 temporal difference 520-2 between a GT image GTₜ₋₁ 503-2 at a second time point on which warping 510-2 is performed by 1-2 motion information MV, 502-2 corresponding to a GT image GTₜ 501-2 at a first time point and the GT image GT; 501-2 at the first time point. Here, the 1-2 motion information MVₜ 502-2 corresponding to the GT image GTₜ 501-2 at the first time point and the 1-1 motion information MVₜ 502-1 corresponding to the input image Iₜ 501-1 at the first time point may be the same as each other.

In operation 460, the electronic device may calculate a 2-2 temporal difference 540-2 between a GT image GTₜ₋₂ 505-2 at a third time point on which warping 530-2 is performed by 2-2 motion information MVₜ₋₁ 504-2 corresponding to a GT image GTₜ₋₁ 503-2 at a second time point and the GT image GTₜ₋₁ 503-2 at the second time point.

In operation 470, the electronic device may perform warping 550-2 on the 2-2 temporal difference 540-2 by the 1-2 motion information MVₜ 502-2.

In operation 480, the electronic device may calculate a 3-2 temporal difference 560-2 between the 2-2 temporal difference 540-2 on which the warping 550-2 is performed and the 1-2 temporal difference 520-2 calculated in operation 440.

In operation 490, the electronic device may calculate a fourth temporal difference 570 between the 3-1 temporal difference 560-1 calculated in operation 440 and the 3-2 temporal difference 560-2 calculated in operation 480.

In operation 495, the electronic device may obtain a temporal characteristic corresponding to the input image Iₜ 501-1 at the first time point by the fourth temporal difference 570 calculated in operation 490.

As described above, when there is a GT image(s) corresponding to a rendering image(s), the electronic device may transmit an existing high-quality image by reducing its size to fit a limited capacity, such as during transmission between a server and a mobile device, rather than in an interactive system. Even when the electronic device transmits an input image by compressing it with frame-adaptive compressibility that adjusts or changes the input image according to a given condition or environment, stable transmission quality may be maintained by keeping the degree of temporal characteristic (temporal stability) consistent.

When there are GT images corresponding to input images (e.g., rendering images), the electronic device may apply the same process (e.g., calculating the 1st derivative and the 2nd derivative) as the input images to the GT images. The electronic device may use, as the final image quality measurement value, the fourth temporal difference 570 calculated by the comparison result between the 3-1 temporal difference 560-1 calculated by the input image Iₜ 501-1, the input image Iₜ₋₁ 503-1, and input image Iₜ₋₂ 505-1 and the 3-2 temporal difference 560-2 calculated by the GT image GT: 501-2, the GT image GTₜ₋₁ 503-2, and the GT image GTₜ₋₂ 505-2. The electronic device may improve training stability using the fourth temporal difference 570 or a value 580 obtained by processing the fourth temporal difference 570 as loss for training a neural network included in a rendering apparatus that generates input images.

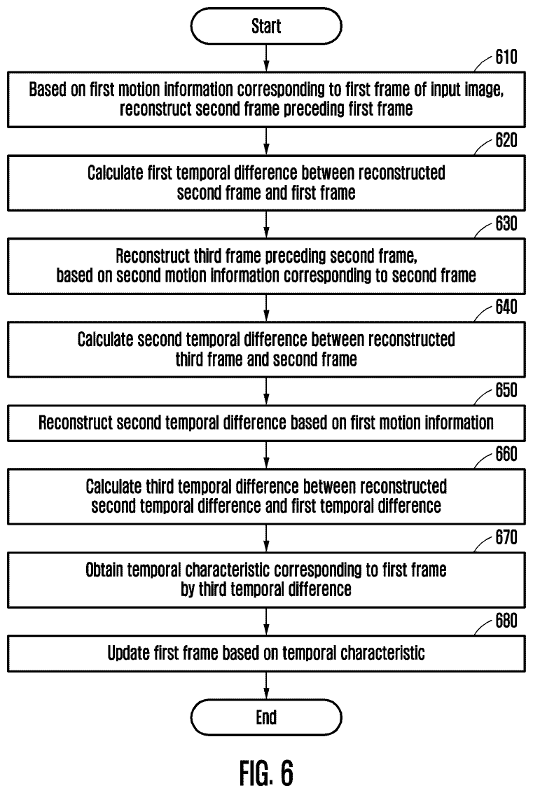

FIG. 6 is a flowchart illustrating a method of obtaining a temporal characteristic, according to an embodiment. Referring to FIG. 6, an electronic device according to an embodiment may update a first frame through operations 610 to 680.

In operation 610, the electronic device may reconstruct, based on first motion information corresponding to a first frame of an input image, a second frame preceding the first frame.

In operation 620, the electronic device may calculate a first temporal difference between the second frame reconstructed in operation 610 and the first frame.

In operation 630, the electronic device may reconstruct a third frame preceding the second frame, based on second motion information corresponding to the second frame.

In operation 640, the electronic device may calculate a second temporal difference between the third frame reconstructed in operation 630 and the second frame.

In operation 650, the electronic device may reconstruct the second temporal difference based on the first motion information.

In operation 660, the electronic device may calculate a third temporal difference between the second temporal difference reconstructed in operation 650 and the first temporal difference calculated in operation 620.

In operation 670, the electronic device may obtain a temporal characteristic corresponding to the first frame by the third temporal difference calculated in operation 660.

In operation 680, the electronic device may update the first frame based on the temporal characteristic obtained from operation 670.

FIG. 7 is a block diagram of an electronic device for obtaining a temporal characteristic, according to an embodiment. Referring to FIG. 7, the electronic device 700 according to an embodiment may include a communication interface 710, a processor 730, and a memory 750. The communication interface 710, the processor 730, and the memory 750 may be connected to each other via a communication bus 705.

The electronic device 700 may train neural renderers that may produce a realistic effect with a small amount of operations. In this case, a rendering apparatus may increase coverage for various dynamic elements by configuring a representation for a scene using a compositional generative model. In addition, the rendering apparatus may use an actual photographic image during training together and enable training with a relatively small number of rendered DBs.

The communication interface 710 may be implemented by any one or any combination of a digital modem, a radio frequency (RF) modem, an antenna circuit, a WiFi chip, and related software and/or firmware. The communication interface 710 may receive an input image at a first time point, an input image at a second time point preceding the input image at the first time point, and an input image at a third time point preceding the input image at the second time point. For example, the input image at the first time point, the input image at the second time point, and the input image at the third time point may correspond to sequential image frames according to a constant time interval or an irregular time interval. Alternatively, the input image at the first time point, the input image at the second time point, and the input image at the third time point may be photographic images or video images captured according to a constant time interval or an irregular time interval.

The processor 730 may calculate a first temporal difference between an input image at a second time point reconstructed by first motion information corresponding to the input image at the first time point received through the communication interface 710 and the input image at the first time point. The processor 730 may calculate a second temporal difference between an input image at a third time point reconstructed by second motion information corresponding to the input image at the second time point and the input image at the second time point. The processor 730 may calculate a third temporal difference between the second temporal difference warped by the first motion information and the first temporal difference. The processor 730 may determine a temporal characteristic corresponding to the input image at the first time point by the third temporal difference.

The memory 750 may store a pre-trained artificial neural network-based generative model. The generative model may be a pre-trained artificial neural network-based model configured to generate a rendering image through, for example, a matrix multiplication operation, a convolution operation, an artificial intelligence (AI) operation, and/or high-performance computing (HPC) processing but is not necessarily limited thereto.

In addition, the memory 750 may store various pieces of information generated during the processing process by the processor 730 described above. In addition, the memory 750 may store a variety of data and programs. The memory 750 may include a volatile memory or a non-volatile memory. The memory 750 may include a high-capacity storage medium such as a hard disk to store a variety of data.

In addition, the processor 730 may perform the methods described with reference to FIGS. 1 to 6 and an algorithm corresponding to the methods.

The processor 730 may execute a program and control the electronic device 700. Code of the program executed by the processor 730 may be stored in the memory 750. The processor 730 may be, for example, a mobile application processor (AP) but is not necessarily limited thereto. Alternatively, the processor 730 may be a hardware-implemented electronic device having a physically structured circuit to execute desired operations. For example, the desired operations may include code or instructions in a program. For example, the rendering apparatus that is hardware-implemented may include, for example, a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents. Accordingly, other implementations are within the scope of the following claims.

What is claimed is:

1. A method of obtaining a temporal characteristic, the method comprising:
obtaining a first image at a first time point, a second image at a second time point preceding the first time point, and a third image at third time point preceding the second time point;
reconstructing the second image based on first motion information of the first image;
calculating a first temporal difference between the first image and the reconstructed second image;
reconstructing the third image based on second motion information of the second image;
calculating a second temporal difference between the second image and the reconstructed third image;
reconstructing the second temporal difference based on the first motion information;
calculating a third temporal difference between the reconstructed second temporal difference and the first temporal difference; and
obtaining a temporal characteristic of the first image based on the third temporal difference.

2. The method of claim 1, wherein the calculating of the first temporal difference comprises:
obtaining the first motion information;
warping the second image based on the first motion information; and
calculating the first temporal difference by comparing the warped second image with the first image.

3. The method of claim 1, wherein the calculating of the second temporal difference comprises:
obtaining the second motion information;
warping the third image based on the second motion information; and
calculating the second temporal difference by comparing the warped third image with the second image.

4. The method of claim 1, wherein the first motion information and the second motion information comprise either one or both of a motion vector and optical flow.

5. The method of claim 1, further comprising:
preprocessing at least some area of at least one of the first image, the second image, the third image, the reconstructed second image, and the reconstructed third image.

6. The method of claim 5, wherein the preprocessing comprises at least one of:
adding blur to the at least some area; and
smoothing the at least some area.

7. The method of claim 1, wherein at least one of the first temporal difference, the second temporal difference, and the third temporal difference is defined in a form of a spatial map.

8. The method of claim 1, wherein at least one of the first temporal difference and the second temporal difference comprises at least one of:
a difference between pixels mapped to each other in input images at each time point;
a difference between areas mapped to each other in the input images at the each time point;
a difference based on features extracted from the input images at the each time point;
a difference between image error metrics corresponding to the input images at the each time point; and
a difference between maps or images corresponding to the input images at the each time point.

9. The method of claim 1, further comprising:
estimating occlusion areas in the first, second and third images based on additional information corresponding to the first, second, and third images; and
removing the occlusion areas from the first, second, and third images by masking the occlusion areas.

10. The method of claim 9, wherein at least one of the first temporal difference, the second temporal difference, and the third temporal difference is calculated for the first, second, and third images from which the occlusion areas are removed.

11. The method of claim 9, wherein the additional information comprises at least one of depth information corresponding to the first, second, and third images, normal information corresponding to at least one object comprised in the first, second, and third images, and object identification (ID) information corresponding to the at least one object.

12. The method of claim 1, wherein the calculating of the third temporal difference comprises:
processing a spatial map corresponding to the third temporal difference; and
estimating, as the third temporal difference, a value calculated as a result of the processing.

13. The method of claim 12, wherein the processing of the spatial map comprises:
comparing pixel values of the spatial map corresponding to the third temporal difference with a threshold; and
calculating, as the third temporal difference, a value obtained by averaging results of the comparison with the threshold.

14. The method of claim 12, wherein the processing of the spatial map comprises calculating at least one of a weighted average, a mean squared error (MSE), a peak signal-to-noise ratio (PSNR), and a structural similarity (SSIM) index for pixel values of the spatial map corresponding to the third temporal difference.

15. The method of claim 12, wherein the obtaining of the temporal characteristic comprises obtaining the temporal characteristic by comparing the estimated value with a preset reference.

16. The method of claim 1, further comprising:
updating the first image based on the temporal characteristic.

17. The method of claim 1, further comprising:
adaptively adjusting a rendering quality by training a neural network that renders the first, second, and third images, based on the temporal characteristic.

18. A method of obtaining a temporal characteristic, the method comprising:
obtaining a first image and a first ground truth (GT) at a first time point, a second image and a second GT image at a second time point preceding the first time point, and a third image and a third GT image at third time point preceding the second time point;
warping the second image based on 1-1 motion information of the first image;
calculating a 1-1 temporal difference between the first image and the warped second image;
warping the third image based on 2-1 motion information of the second image;
calculating a 2-1 temporal difference between the second image and the warped third image;
warping the 2-1 temporal difference based on the 1-1 motion information;
calculating a 3-1 temporal difference between the warped 2-1 temporal difference and the 1-1 temporal difference;
warping the second GT image based on 1-2 motion information of the first GT image;
calculating a 1-2 temporal difference between the first GT image and the warped second GT image;
warping the third GT image based on 2-2 motion information of the second GT image;
calculating a 2-2 temporal difference between the second GT image and the third GT image;
warping the 2-2 temporal difference based on the 1-2 motion information;
calculating a 3-2 temporal difference between the warped 2-2 temporal difference and the 1-2 temporal difference;
calculating a fourth temporal difference between the 3-1 temporal difference and the 3-2 temporal difference; and
obtaining a temporal characteristic of the first image based on the fourth temporal difference.

19. A method of obtaining a temporal characteristic, the method comprising:
obtaining an input image comprising a first frame, a second frame preceding the first frame, and a third frame preceding the second frame;
reconstructing the second frame based on first motion information of the first frame;
calculating a first temporal difference between the reconstructed second frame and the first frame;
reconstructing the third frame based on second motion information of the second frame;
calculating a second temporal difference between the reconstructed third frame and the second frame;
reconstructing the second temporal difference based on the first motion information;
calculating a third temporal difference between the reconstructed second temporal difference and the first temporal difference;
obtaining a temporal characteristic of the first frame based on the third temporal difference; and
updating the first frame based on the temporal characteristic.

20. The method of claim 19, wherein the reconstructing of the second frame comprises:
obtaining the first motion information; and
warping the second frame preceding the first frame by the first motion information,
wherein the calculating of the first temporal difference comprises calculating the first temporal difference by comparing the warped second frame with the first frame.
